(19) United States
(12) Patent Application Publication
(10) Pub. No.: US 2017/0030280 A1
(43) Pub. Date: Feb. 2, 2017

(54) METHOD FOR OPERATING AN ENGINE OF A MACHINE

(71) Applicant: Caterpillar Inc., Peoria, IL (US)

(72) Inventors: Justin L. Steinlage, Mackinaw, IL (US); Nathan S. Pauli, Peoria, IL (US); Lawrence D. Hasfjord, Chillicothe, IL (US); Brian A. Byers, Decatur, IL (US)

(73) Assignee: Caterpillar Inc., Peoria, IL (US)

(21) Appl. No.: 15/290,956

(22) Filed: Oct. 11, 2016

(51) Int. Cl. F02D 41/10; F02D 41/26; F02D 31/00

(52) U.S. Cl. CPC F02D 41/107; F02D 31/001; F02D 41/26

(57) ABSTRACT

A method for operating an engine of a machine is provided. The method determines a first engine operating speed of the engine from an engine speed detection module using a controller and then determines a current throttle position of the machine using a throttle detection module using the controller. The method further includes calculating a throttle-to-minimum engine operating speed map based on a correlation of the current throttle position and the first engine operating speed using the controller. The throttle-to-minimum engine operating speed map is lesser than the first engine operating speed. The method selectively regulates a current operating speed of the engine based on the throttle-to-minimum engine operating speed map using the controller, if the trigger event persists. The method selectively regulates the current operating speed of the engine based on the first engine operating speed using the controller, if the trigger event does not persist.

### TECHNICAL FIELD

The present disclosure relates to control systems, and more specifically, to a method for operating an engine of a machine.

### BACKGROUND

Earth moving machines, such as wheel tractor scrapers, wheel loaders are used for performing a variety of operations. In general, the wheel tractor scrapers have complex features, such as loading gears, aprons, implements, i.e. elevators and augers, among others. Therefore, operators may be required to operate the wheel tractor scrapers in an efficient manner.

Conventionally, there exist various techniques for efficiently operating the wheel tractor scrapers. For example, one such conventional technique includes mapping of an engine power output to throttle. However it may be cumbersome for operators to control the wheel tractor scrapers during step load situations using this technique. As a result, a performance of the wheel tractor scrapers may be degraded. Further, it may be difficult for the operators to operate the wheel tractor scrapers during unknown load conditions. Therefore, such challenges may hamper comfort level of the operators, reduce working efficiency, and may result in decreased productivity.

Chinese Publication Number 102826013 describes a method, a device and a system for controlling a hydrostatic power transmission system. The device comprises a minimum rotational speed acquisition module, an engine rotational speed control mechanism and a control quantity acquisition module. An engine rotational speed calculating mechanism acquires load power according to data acquired by a motor rotational speed sensor and a hydraulic motor pressure sensor, and then acquires the minimum rotational speed of an engine according to the load power. The engine rotational speed control mechanism controls rotational speed of the engine according to the minimum rotational speed.

Therefore, there is a need for an improved method for operating an engine of a machine.

### SUMMARY OF THE DISCLOSURE

In one aspect of the present disclosure, a method for operating an engine of a machine is provided. The method determines a first engine operating speed of the engine from an engine speed detection module using a controller and then determines a current throttle position of the machine from a throttle detection module using the controller. The method further includes calculating a throttle-to-minimum engine operating speed map based on a correlation of the current throttle position and the first engine operating speed using the controller. The throttle-to-minimum engine operating speed map is lesser than the first engine operating speed at the current throttle position. The method selectively regulates a current operating speed of the engine based on the throttle-to-minimum engine operating speed map using the controller, if the trigger event persists. The method selectively regulates the current operating speed of the engine based on the first engine operating speed using the controller, if the trigger event does not persist.

Other features and aspects of this disclosure will be apparent from the following description and the accompanying drawings.

### BRIEF DESCRIPTION OF THE DRAWINGS

FIG. 1 is a side view of an exemplary machine, in accordance with the concepts of the present disclosure;

FIG. 2 is a block diagram of a system for operating the machine, in accordance with the concepts of the present disclosure;

FIG. 3 is a flow diagram of a method for operating the machine, in accordance with an embodiment of the present disclosure; and

FIG. 4 is a flow diagram of a method for operating the machine, in accordance with another embodiment of the present disclosure.

### DETAILED DESCRIPTION

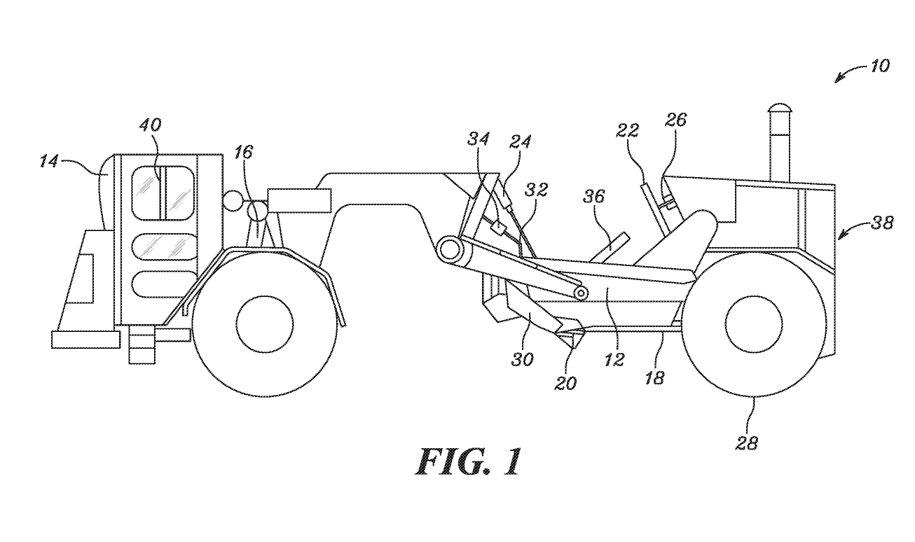

Referring to FIG. 1, an exemplary machine 10 is illustrated. In an embodiment, the machine 10 is a wheel tractor scraper 10. The wheel tractor scraper 10 is used for various operations such as, but not limited to, moving earth, or other operations. The wheel tractor scraper 10 includes a load carrying bowl 12. A tractor 14 is connected to the load carrying bowl 12 by a hydraulic or non-hydraulic hitch 16. The tractor 14 is any conventional tractor that is capable of hauling the wheel tractor scraper 10.

The load carrying bowl 12 includes a floor 18 having a cutting edge 20. A rear wall of the load carrying bowl 12 is formed as a moveable ejector 22. A first set of hydraulic lifts 24 are mounted to a front of the load carrying bowl 12 and a second set of hydraulic lifts 26 are mounted between the moveable ejector 22 and the load carrying bowl 12. The second set of hydraulic lifts 26 may alternatively be mounted between the moveable ejector 22 and another stationary or fixed location such as, for example, rear wheels 28 of the load carrying bowl 12.

An apron 30 is mounted to the load carrying bowl 12 via an articulated support assembly 32. The articulated support assembly 32 is moveable between several positions including an open and closed position by use of a third set of hydraulic lifts 34 mounted to the load carrying bowl 12. Material moving implements 36 such as an elevator or auger may also be positioned within the load carrying bowl 12 proximate to the cutting edge 20. The machine 10 includes an engine 38 for providing power for operating the wheel tractor scraper 10. The machine 10 further includes an operator cabin 40 and a seat (not shown). An operator sits on the seat in the operator cabin 40 for controlling various operations of the machine 10. The machine 10 further includes various other components that are not described here, for the purpose of simplicity. It will be apparent to one skilled in the art that the machine 10 shown in FIG. 1 is the wheel tractor scraper. However, the machine 10 may be any other machine such as, but not limited to, a track-type tractor, a hydraulic mining shovel, or an excavator, without departing from the scope of the disclosure.

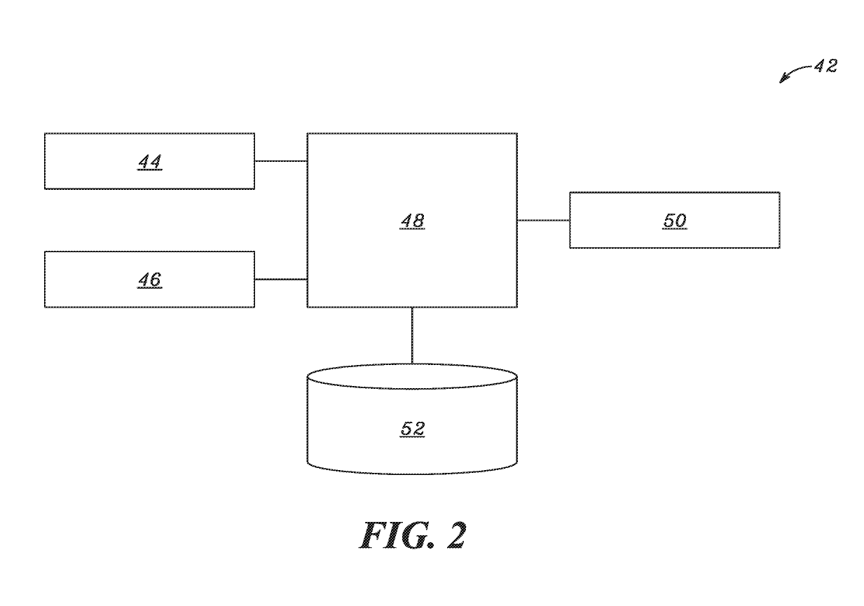

Referring to FIG. 2, a system 42 for operating the engine 38 of the machine 10 is provided. The system 42 includes a throttle detection module 44, and an engine speed detection module 46 operatively coupled with a controller 48. The throttle detection module 44 and the engine speed detection module 46 may utilize various sensors or circuitries as known in the art. The system 42 includes a machine control unit 50 and a database 52. The machine control unit 50 is configured to control various aspects of the system 42, including various hydraulic components associated therewith, as well as related electrical control functions.

The controller 48 detects, if there is an occurrence of a trigger event. The trigger event is a pre-defined event during high transient conditions of the machine 10. The trigger event indicates those situations where step loads are expected, while operating the machine 10. For example, during a dump segment operating cycle or during opening of the apron 30, when the load carrying bowl 12 is full, among others. In an embodiment, other trigger events may be defined based on a type of machines and stored in the database 52. The trigger event may be defined on the basis of historical data and defines events of operating the machine 10 during the high transient conditions or unknown load conditions. The database 52 includes look-up tables for storing the trigger event of the machine 10. The database 52 may be any conventional or non-conventional database known in the art. In one embodiment, the database 52 may be extrinsic to the machine 10 and located at a remote location away from the machine 10. Alternatively, the database 52 may be intrinsic to the machine 10. In an embodiment, the trigger event may be determined based on the historical data, may be obtained from reports, an external source or a repository associated with the machine 10, without departing from the scope of the disclosure.

The controller 48 is coupled to the throttle detection module 44 to receive signals indicative of a throttle position of the engine 38. The controller 48 is further coupled to the engine speed detection module 46 to receive signals indicative of an engine speed. After detecting the trigger event, the controller 48 receives a first engine operating speed of the engine 38 from the engine speed detection module 46. The first engine operating speed is a speed at which the engine 38 operates during a time segment at a beginning of the trigger event. The first engine operating speed is calculated based on a throttle command of the engine 38. After detecting the trigger event, the controller 48 receives a current throttle position of the machine 10 from the throttle detection module 44. The current throttle position is derived based on the throttle command during the time segment at the beginning of the trigger event. The controller 48 calculates a throttle-to-minimum engine operating speed map based on a correlation of the current throttle position and the first engine operating speed. The throttle-to-minimum engine operating speed map is lesser than the first engine operating speed at the current throttle position. In an embodiment, the database 52 may also store various correlation equations or mathematical equations that are defined for a variety of machines based on a historical data, may be obtained from reports, external sources or repositories associated with various machines, without departing from the scope of the disclosure.

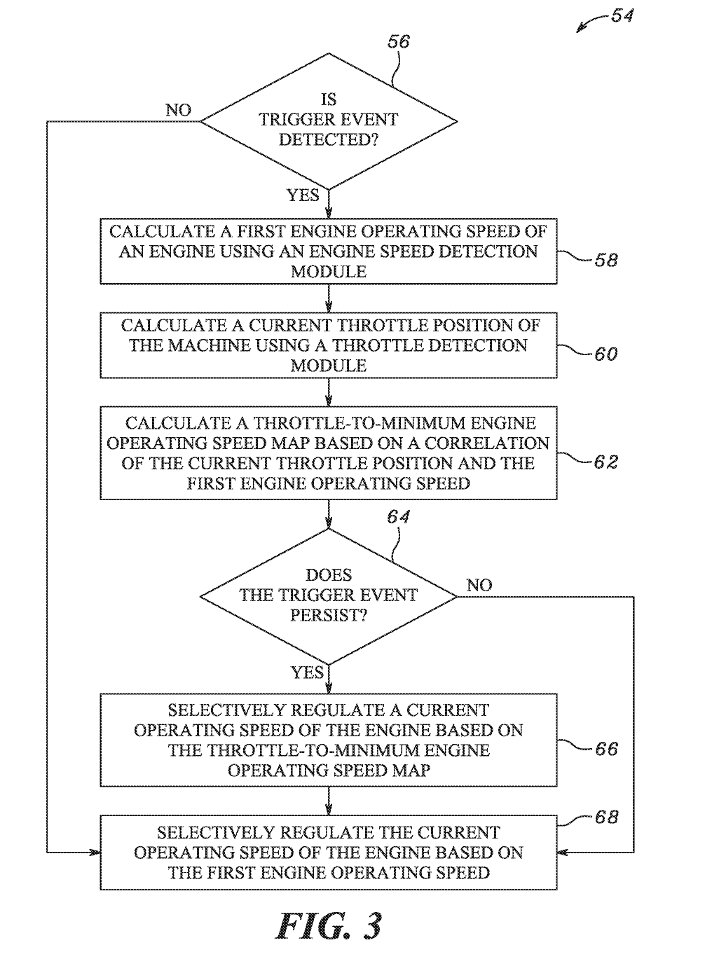

The controller 48 detects, if the trigger event still persists. After detecting that the trigger event still persists, the controller 48 selectively regulates a current operating speed of the engine 38 based on the throttle desired torque or power and the throttle-to-minimum engine operating speed map. The current operating speed is an analogue value that may vary between a specific operating range according to a design of the engine 38. If the trigger event does not persist, the controller 48 selectively regulates the current operating speed of the engine 38 based on the throttle desired torque or power command. As an illustrative example, after detecting the trigger event, the controller 48 regulates the engine 38 at the throttle-to-minimum engine operating speed map based on the correlation according to an engine algorithm. If there is no trigger event, the engine 38 continues to operate at the power or torque commanded by the operator. The detailed operation of the system 42 is described in conjunction with FIG. 3 below.

Referring to FIG. 3, a method 54 for operating the machine 10 is described, in accordance with an embodiment of the present disclosure. The method 54 is described in conjunction with FIGS. 1 and 2.

At step 56, the controller 48 detects if the trigger event is detected. If the controller 48 detects the trigger event, the method 54 moves to step 58. Else, the method 54 moves to step 68. At step 58, the first engine operating speed of the engine 38 is calculated using the engine speed detection module 46. At step 60, the current throttle position of the machine 10 is calculated using the throttle detection module 44. At step 62, the throttle-to-minimum engine operating speed map is calculated by the controller 48 based on the correlation of the current throttle position and the first engine operating speed.

At step 64, the controller 48 detects if the trigger event still persists. If the controller 48 detects the trigger event still persists, the method 54 moves to step 66. Else, the method 54 moves to step 68. At step 66, the current operating speed of the engine 38 is selectively regulated, by the controller 48, based on the throttle-to-minimum engine operating speed map. At step 68, the current operating speed of the engine 38 is selectively regulated, by the controller 48, based on the first engine operating speed.

It should be noted that the controller 48 is an electronic controller that is remotely coupled with an engine control module (ECM) of the engine 38 for carrying out various operations. The controller 48 may be a logic unit using any one or more of a processor, a microprocessor, and a microcontroller. The controller 48 may be based on an integrated circuitry, discrete components, or a combination of the two. Further, other peripheral circuitry, such as buffers, latches, switches, and the like may be implemented within the controller 48 or separately connected to the controller 48. It will be apparent to one skilled in the art that the controller 48 mentioned above may be an individual component which is in communication with other circuitries of the system 42. The controller 48 may be networked over a serial communication bus such as a controller area network (CAN) bus (not shown). Other arrangements of microcontrollers and microprocessors may be used. There may be other sensors or modules that may be connected to the controller 48 that provide the controller 48 with data for various operating conditions. The controller 48 may include a memory, a secondary storage device, a processor, and any other components for running an application. Various other circuits may be associated with the controller 48 such as a power supply circuitry, a signal conditioning circuitry, a solenoid driver circuitry, and other types of circuitry.

### INDUSTRIAL APPLICABILITY

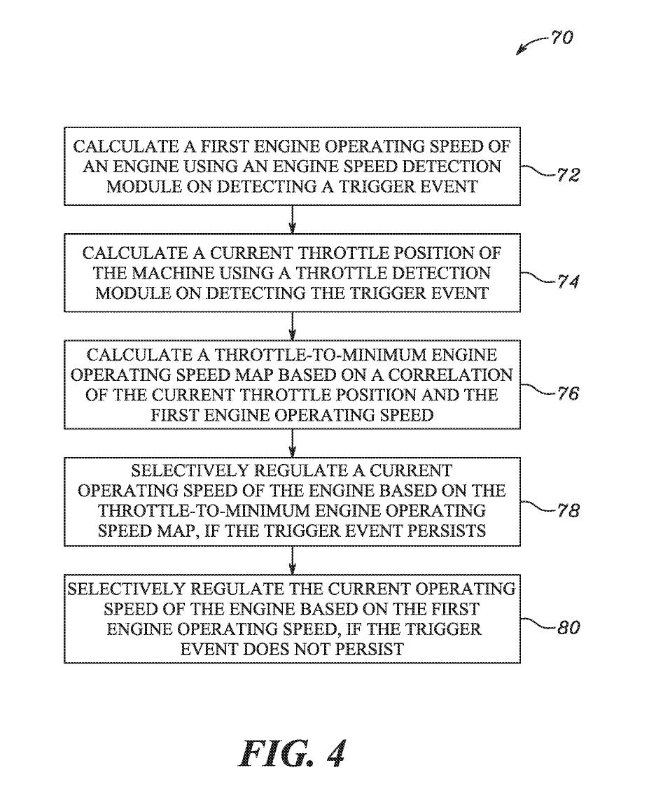

Referring to FIG. 4, a method 70 for operating the machine 10 is described, in accordance with another embodiment of the present disclosure.

At step 72, the first engine operating speed of the engine 38 is calculated using the engine speed detection module 46, if the trigger event is detected. At step 74, the current throttle position of the machine 10 is calculated using the throttle detection module 44, if the trigger event is detected.

At step 76, the throttle-to-minimum engine operating speed map is calculated by the controller 48 based on the correlation of the current throttle position and the first engine operating speed. At step 78, the current operating speed of the engine 38 is selectively regulated, by the controller 48, based on the throttle-to-minimum engine operating speed map. At step 80, the current engine operating speed of the engine 38 is selectively regulated, by the controller 48, based on the first engine operating speed, if the trigger event does not persist.

The proposed disclosure utilizes the controller 48 for selectively regulating, in a real-time manner, the current operating speed of the engine 38 based on the throttle-to-minimum engine operating speed map, if the trigger event is detected. The system 42 may be easily configured for regulating the current operating speed during unknown load conditions. The system 42 utilizes a simple algorithm for managing the current operating speed of the engine 38, and hence there is no requirement for additional complex systems. The system 42 may define various trigger events as per operating parameters of various machines, not limiting to the wheel tractor scraper.

The system 42 may be implemented for other work machines, such as the track-type tractor, the hydraulic mining shovel, or the excavator and the like. The system 42 enables the operator to smoothly operate the machine 10 by automatically accounting an unexpected load by regulating the engine 38 at the throttle-to-minimum engine operating speed map. An operator intervention is minimized as the system 42 automatically operates the engine 38 during the trigger events. The system 42 offers a greater reliability and efficiency for the machine 10 that result in fewer downtime periods. Further, the system 42 offers a fast, reliable, and smooth operation of the machine 10.

The system 42 enhances performance and operability of the machine 10 even during step load situations. The system 42 enables the operator to focus on a task at hand by alleviating a need for the operator to continuously manage an engine speed.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for operating an engine of a machine, the method comprising:
detecting, by a controller, an occurrence of a trigger event;
determining, by the controller, a first engine operating speed of the engine using an engine speed detection module based on the detection;
determining, by the controller, a current throttle position of the machine using a throttle detection module based on the detection;
calculating, by the controller, a throttle-to-minimum engine operating speed map based on a correlation of the current throttle position and the first engine operating speed, wherein the throttle-to-minimum engine operating speed map is lesser than the first engine operating speed at the current throttle position;
selectively regulating, by the controller, a current operating speed of the engine based on the throttle-to-minimum engine operating speed map if the trigger event persists; and
selectively regulating, by the controller, the current operating speed of the engine based on the first engine operating speed if the trigger event does not persist.

2. The method of claim 1, wherein the trigger event is a pre-defined event during high transient condition of the machine.
